(19) United States
(12) Patent Application Publication
(10) Pub. No.: US 2003/0004785 A1
(43) Pub. Date: Jan. 2, 2003

(54) Article staff evaluation system, and medium

(75) Inventor: Mitsuru Hirota, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/098,149

(22) Filed: Mar. 15, 2002

(30) Foreign Application Priority Data
Jun. 27, 2001 (JP) 2001-195197

(51) Int. Cl. G06F 17/60

(52) U.S. Cl. 705/10

(57) ABSTRACT

An evaluation system for evaluating a article staff in charge of trading an article includes a unit (2, 3) inputting occurrence information indicating an occurrence of a loss of sales chance of the article, a module (12) recording article information on the article, and a unit (1) evaluating the article staff in charge of the trade of the article on the basis of the occurrence information and attributes of the article.

### BACKGROUND OF THE INVENTION

The present invention relates to an evaluation system for evaluating a staff member for stocking articles. At a department store and a volume-sales shop, stocking of the articles, which is so-called “preparations of articles”, is quite important work that affects the business. This work is normally performed by staff known as buyers or distributors (who may be called shop salesclerks in some cases).

What has hitherto been a general system for evaluating such a work is based on a sales volume and a profit of the articles sold. Then, the evaluation based on the articles sold does not account for a situation in which the article could not be sold though it would be sold in usual state. This is because the information on the article sold is easy to obtain, but the information on the article that was not sold is hard to obtain.

Further, the information indicating a loss of sales chance such as “this article would be sold if stocked” does not simply raise a problem that the sales volume is short, but gives such a risky signal that the customer's trust might be lost on occasions or the customer might fleet to other retail shops.

Accordingly, the buyer with a small quantity of losses of sales chance must be evaluated high, while the buyer with a large quantity of losses of sales chance must be evaluated low. According to the prior art, however, the evaluation is based on the articles sold, and therefore an achievement of the staff member such as the buyer etc was not necessarily evaluated in precision.

### SUMMARY OF THE INVENTION

It is a primary object of the present invention, which as devised to obviate the problems inherent in the prior art, to provide a technology capable of accurately evaluating the staff such as buyers etc by grasping a state of a loss of sales chance of an article.

To accomplish the above object, according to one aspect of the present invention, an article staff evaluation system comprises a module (12) recording article information on an article, a unit (2, 3) inputting occurrence information indicating an occurrence of a loss of sales chance of the article, and a unit (1) evaluating a article staff in charge of a trade of the article on the basis of the occurrence information and attributes of the article.

Herein, the occurrence of the loss of sales chance implies that when there is, for example, an offer of purchasing the article at a retail shop of the article, there is no stock of this article.

Preferably, the article information may contain a sales price of the article, and the evaluation unit (1) may evaluate the article staff in a way that reflects the sales price of the article.

Preferably, the article information may contain information indicating a continuity of a sales frequency of the article, and the evaluation unit (1) may evaluate the article staff in a way that reflects the continuity of the sales frequency of the article.

Herein, the article having the continuity of the sales frequency is, e.g., a so-called standard article that is sold continuously. Further, the article having no continuity of the sales frequency is an article of which a sales quantity and a sales count are largely fluctuate depending on, e.g., trends and seasons.

Preferably, the article information may contain information indicating a retail presentation term of the article, the occurrence information may contain an occurrence date of the loss of sales chance, and the evaluation unit (1) may evaluate the article staff in a way that reflects a relationship between the occurrence date and the retail presentation term. Herein, the retail presentation term is a term for which the article is put on sale at retail.

Preferably, the article staff evaluation system may further comprise a module (17) referring to information on a state of inventory of a supplier of the article, and the evaluation unit (1) may evaluate the article staff in a way that reflects the state of inventory of the supplier.

Preferably, the article staff evaluation system may further comprise a module (17) referring to information on a state of inventory of the article in a competitor, and the evaluation unit (1) may evaluate the article staff in a way that reflects the state of inventory of the competitor.

Preferably, the article staff evaluation system may further comprise a module (14) accumulating evaluated results, and a module (14) collecting the evaluated results accumulated.

Preferably, the article staff evaluation system may further comprise a module (11) accumulating the occurrence information, and a module collecting the occurrence information accumulated, and the evaluation unit may evaluate the article staff on the basis of the occurrence information collected.

Preferably, the article staff evaluation system may further comprise a module integrating the number of occurrences of the loss of sales chance, and the evaluation unit may evaluate the article staff in a way that reflects the number of occurrences.

According to another aspect of the present invention, an article staff evaluation method comprises inputting occurrence information indicating an occurrence of a loss of sales chance of the article (S11), referring to article information on the article (S21), and evaluating an article staff in charge of a trade of the article on the basis of the occurrence information and the article information (S22, S23, S24, S42, S53, S60, S61)

Those pieces of occurrence information may be inputted from a terminal connected to a computer and stored in a storage unit of the computer, and the processes described above may be executed by a CPU of the computer. Further, the evaluated result may be outputted to a display device or a printer connected to the computer.

According to still another aspect of the present invention, there is provided a program executed by the computer to actualize any of the functions described above.

According to a further aspect of the present invention, there is provided a readable-by-computer recording medium recorded with such a program.

As explained above, according to the present invention, it is feasible to precisely evaluate the staff such as buyers etc by grasping the state of the loss of sales chance of the article.

### BRIEF DESCRIPTION OF THE DRAWINGS

FIG. 1 is a diagram showing a system architecture of an information processing system in an embodiment of the present invention;

FIG. 2 is a diagram showing a data structure of a loss-of-sales-chance information database 11;

FIG. 3 is a diagram showing a data structure of an article master database 12;

FIG. 4 is a diagram showing a data structure of a buyer master database 13;

FIG. 5 is a diagram showing a data structure of a presentation term degree file;

FIG. 6 is a diagram showing a data structure of a supplier inventory factor file;

FIG. 7 is a diagram showing a data structure of a competitor inventory factor file;

FIG. 8 is a diagram showing a data structure of a loss-of-chance detailed file;

FIG. 9 is a diagram showing a data structure of a buyer-by-buyer evaluation information file;

FIG. 10 is a diagram showing a data structure of a sales chance loss count factor file;

FIG. 11 is a diagram showing a data structure of a buyer-oriented detailed output file;

FIG. 12 is a diagram showing a layout of a degree setting screen;

FIG. 13 is a diagram showing an example of manager-oriented buyer evaluation information;

FIG. 14 is a diagram showing an example of a buyer-oriented sales chance loss detailed table;

FIG. 15 is a flowchart showing an information accumulation process;

FIG. 16 is a flowchart showing an evaluation calculating process;

FIG. 17 is a flowchart showing an option process;

FIG. 18 is a flowchart showing details of a buyer code entry process;

FIG. 19 is a flowchart showing a manager-oriented buyer evaluation information creating process;

FIG. 20 is a flowchart showing a buyer-oriented sales chance loss detailed file creating process;

FIG. 21 is a flowchart showing a screen/document output process; and

FIG. 22 is a flowchart showing an other system interface process.

### DETAILED DESCRIPTION OF THE PREFERRED EMBODIMENT

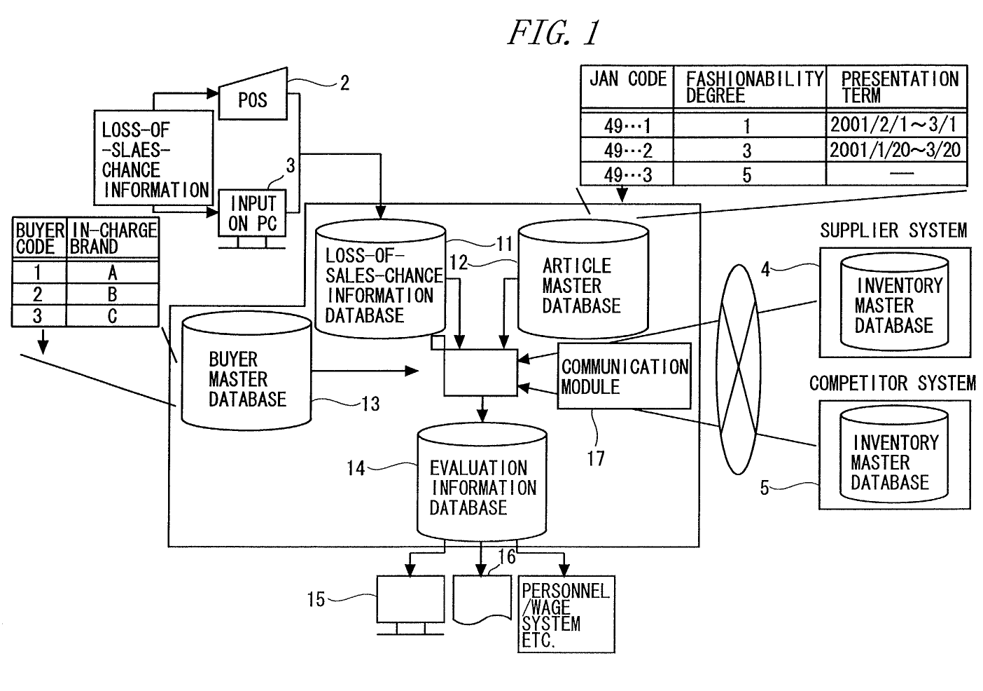

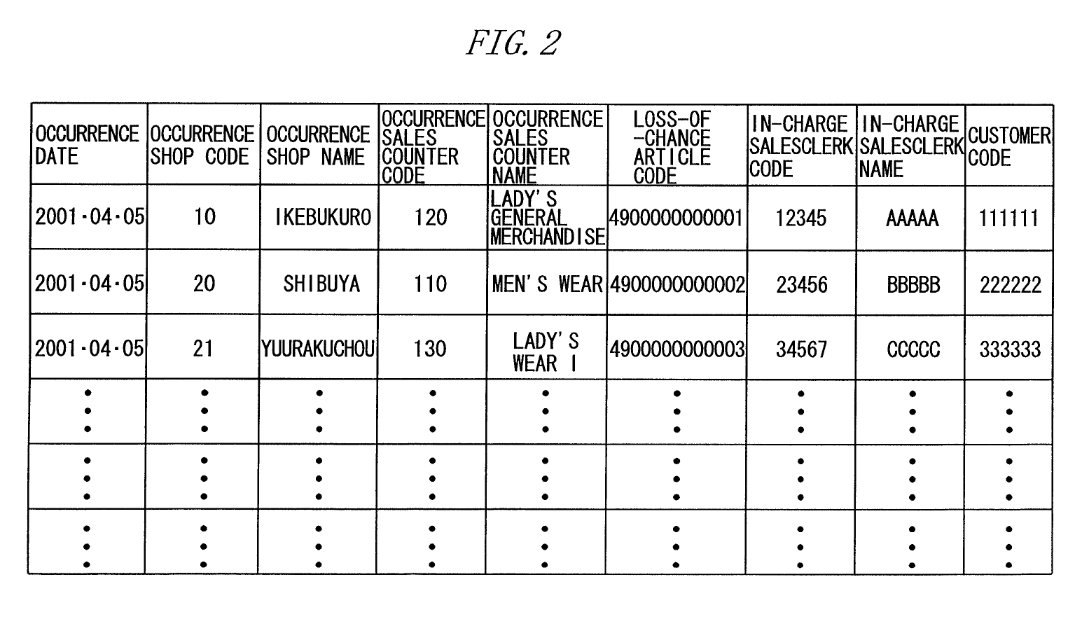

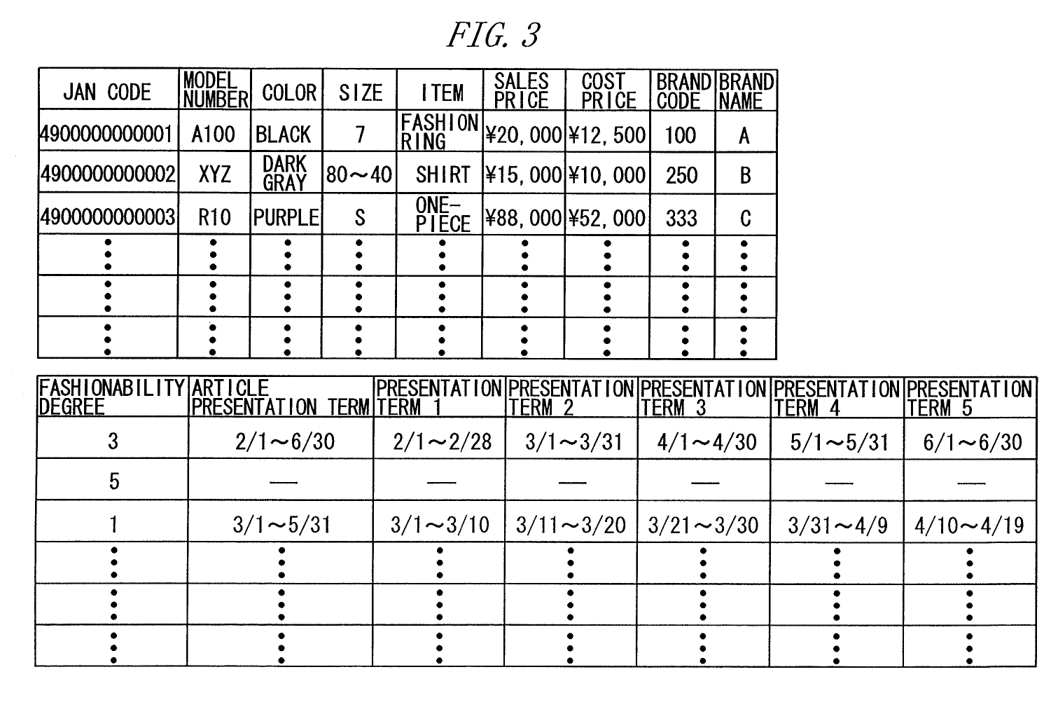

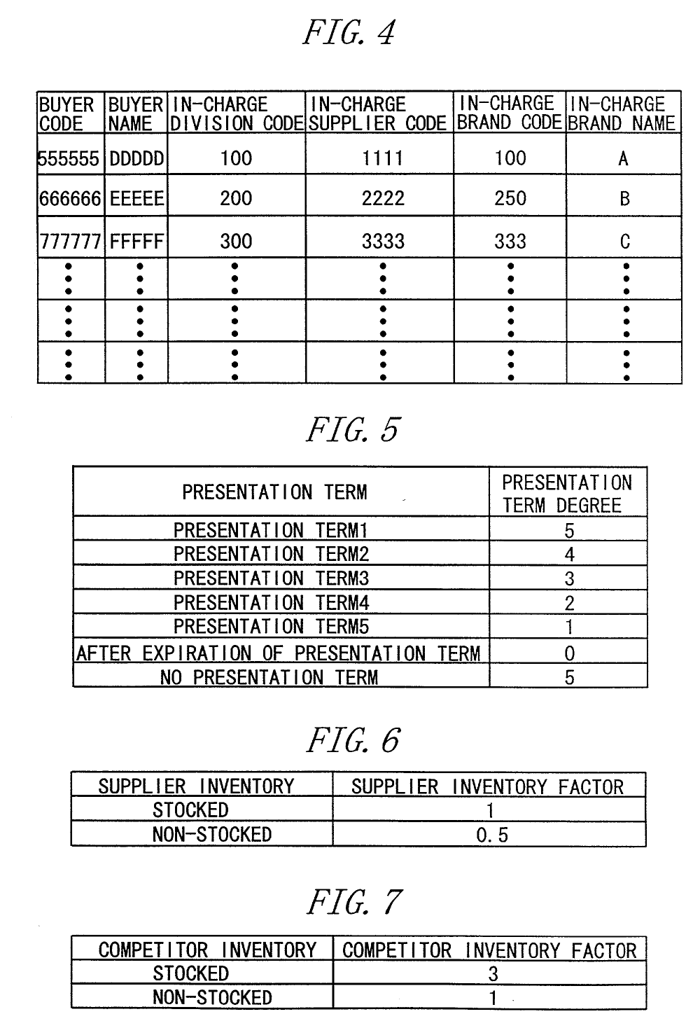

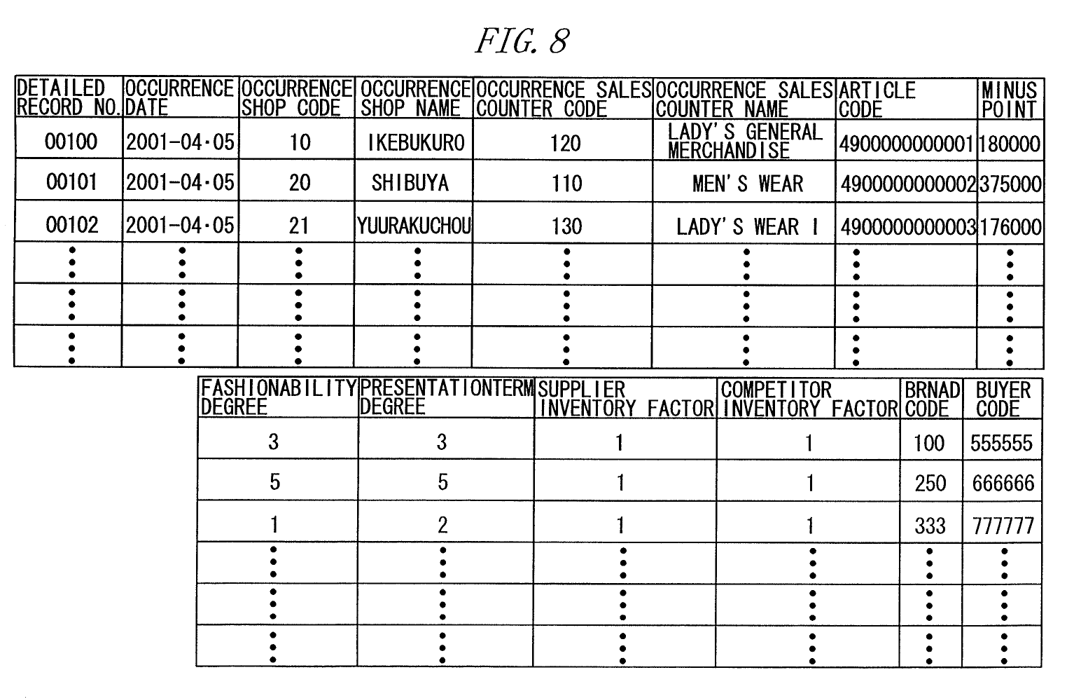

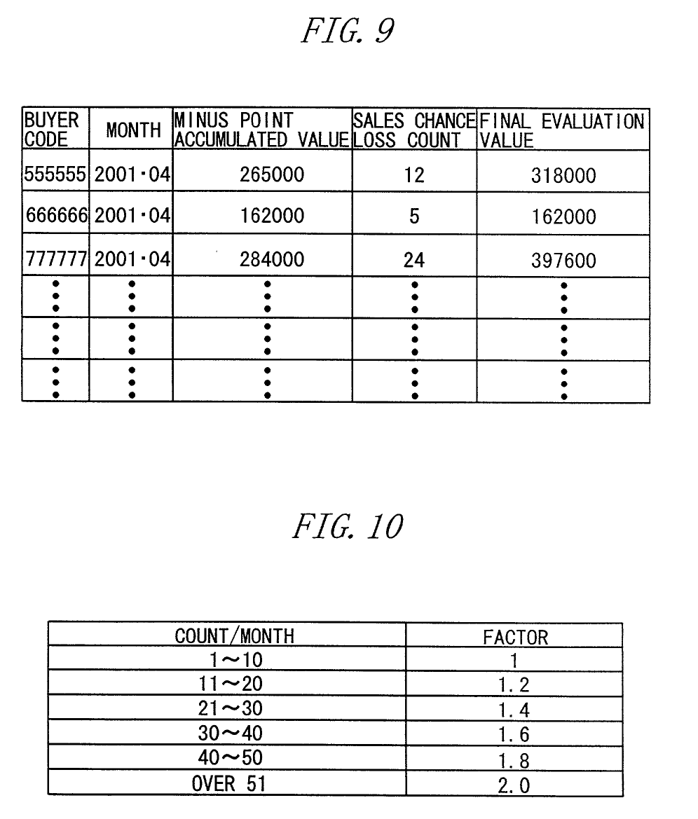

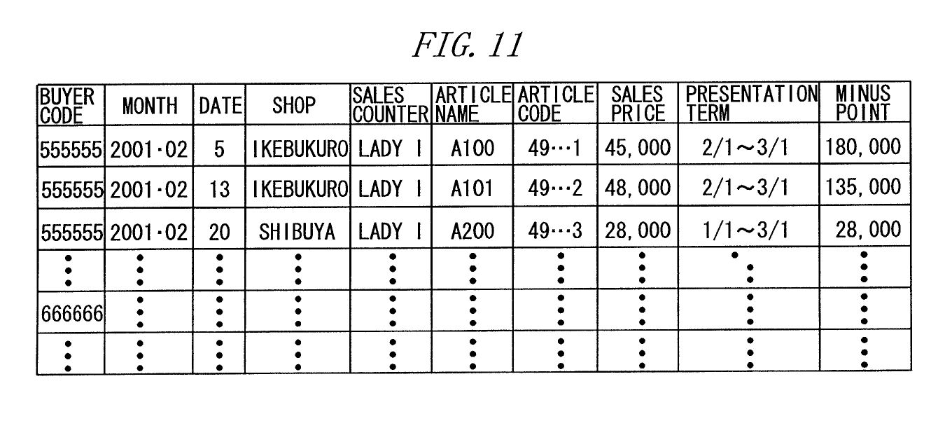

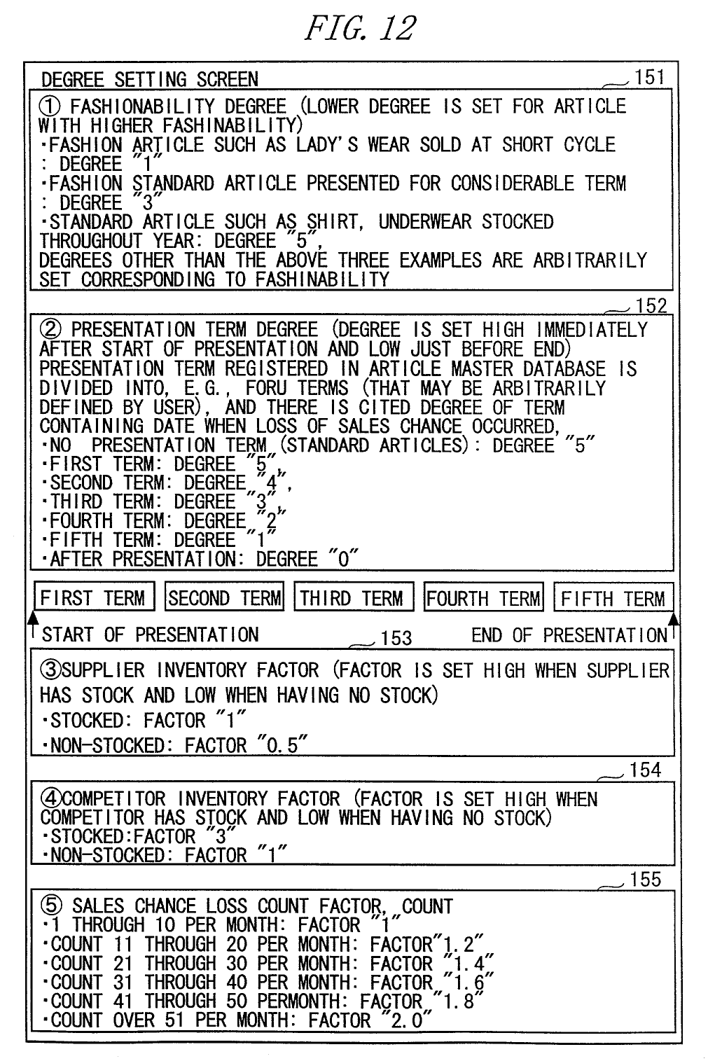

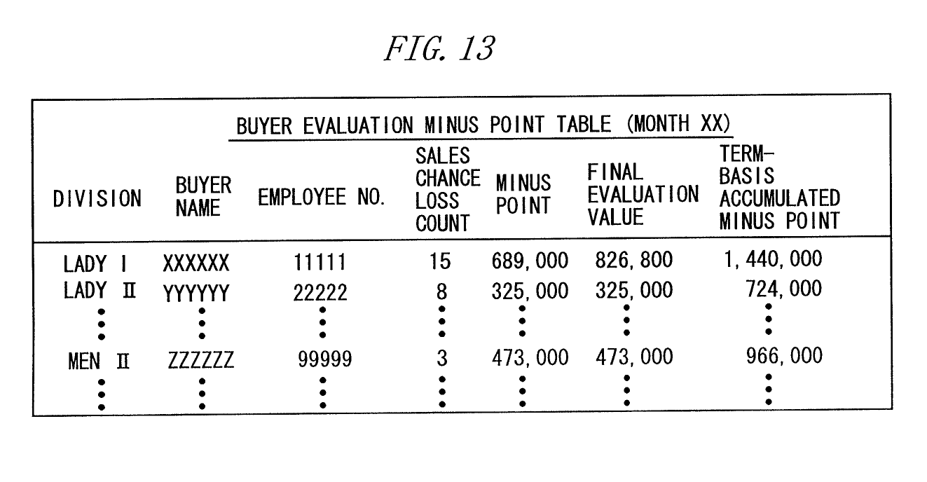

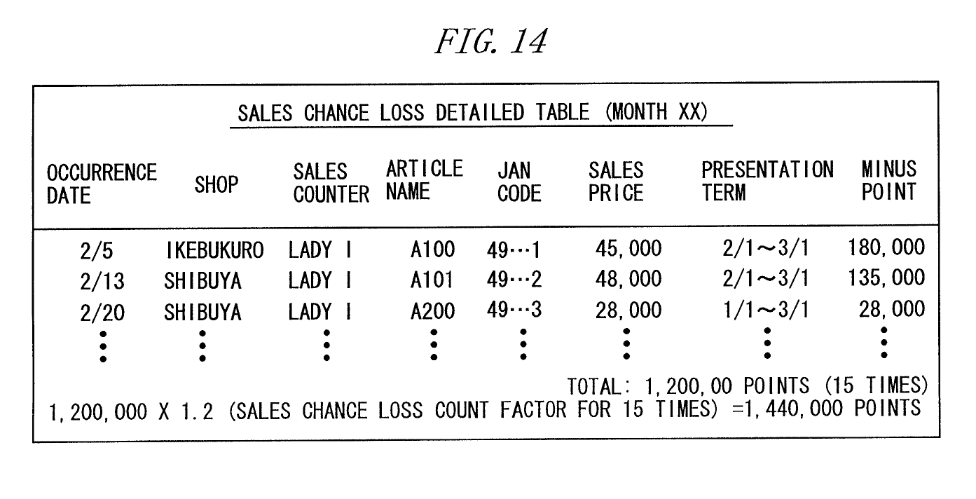

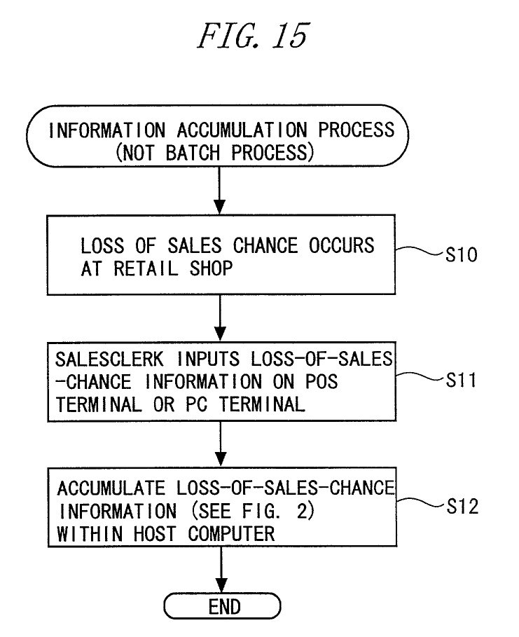

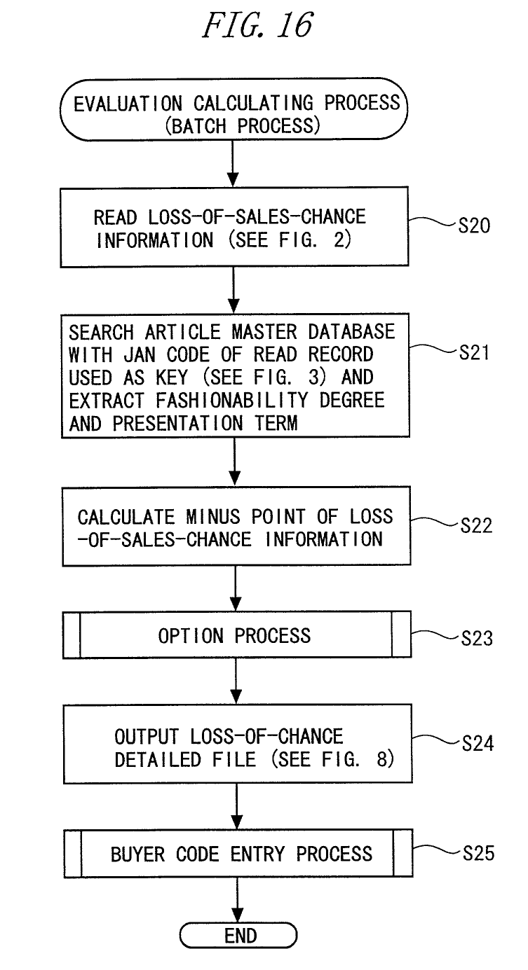

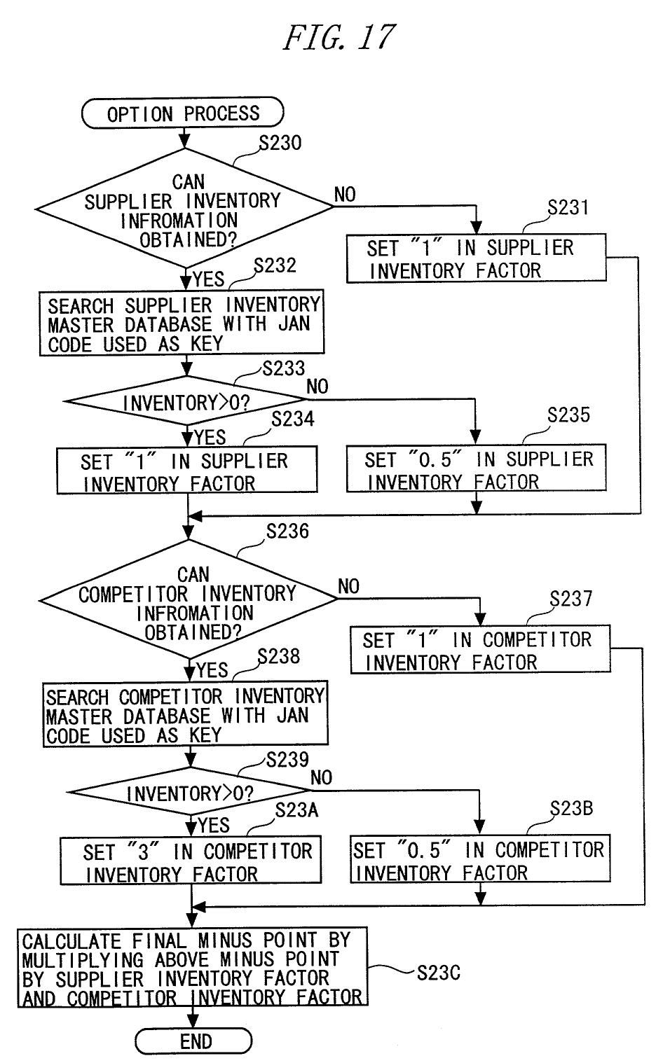

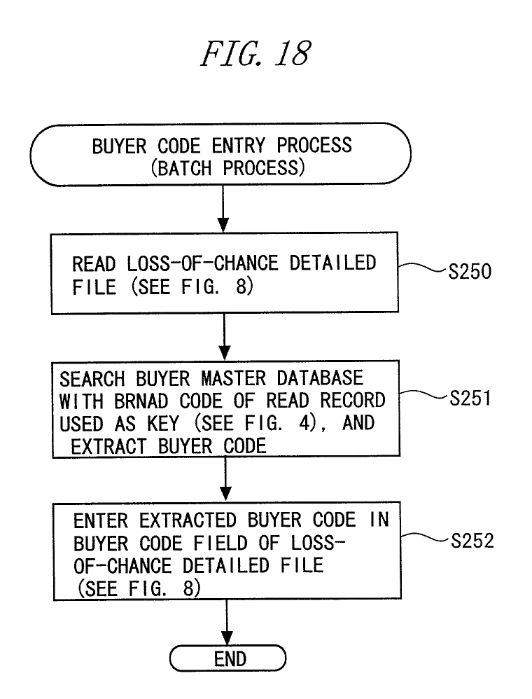

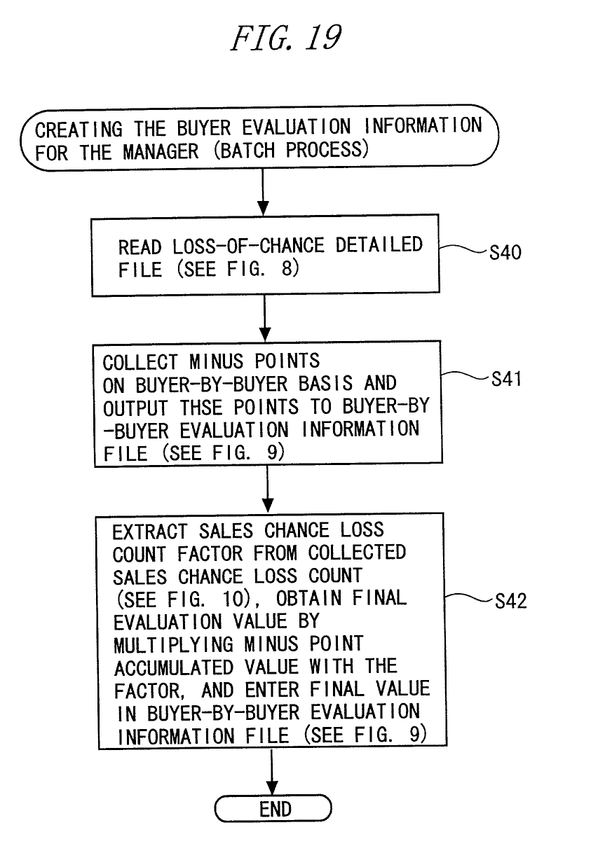

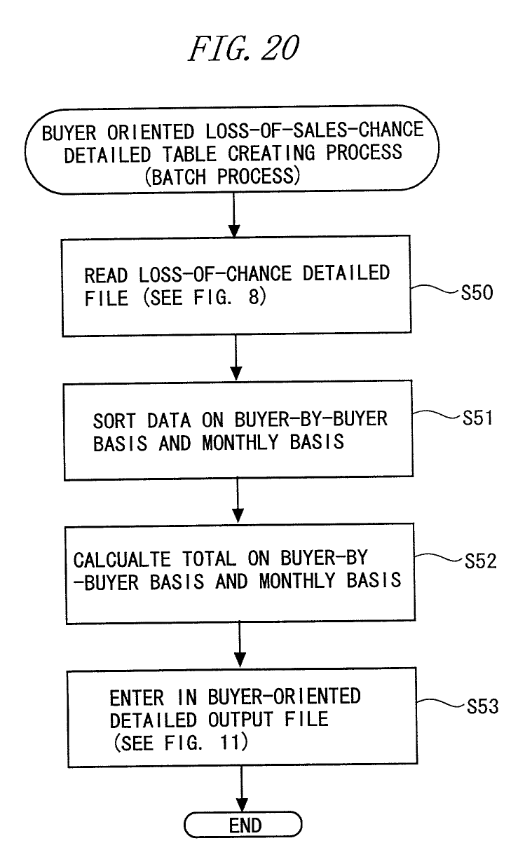

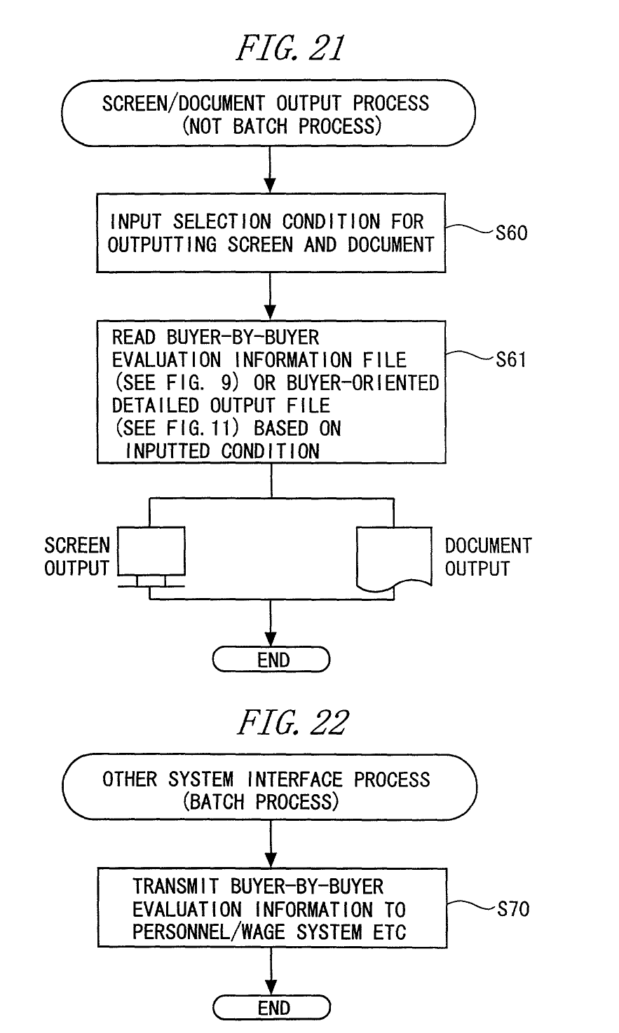

An embodiment of the present invention will hereinafter be described with reference to FIGS. 1 through 22. FIG. 1 is a diagram showing a system architecture of an information processing system in this embodiment. FIG. 2 is a diagram showing a data structure of a loss-of-sales-chance information database 11 illustrated in FIG. 1. FIG. 3 is a diagram showing a data structure of a article master database 12 shown in FIG. 1. FIG. 4 is a diagram showing a data structure of a buyer master database 13 shown in FIG. 1. FIG. 5 is a diagram showing a data structure of a presentation term degree file used in this information processing system. FIG. 6 is a diagram showing a data structure of a supplier inventory factor file recording a buyer evaluation factor depending on whether the supplier has a stock or not. FIG. 7 is a diagram showing a data structure of a competitor inventory factor file; for recording a buyer evaluation factor depending on whether the competitor has a stock or not. FIG. 8 is a diagram showing a data structure of a loss-of-chance detailed file. FIG. 9 is a diagram showing a data structure of a buyer-by-buyer evaluation information file for gathering the evaluations of the buyers. FIG. 10 is a diagram showing a data structure of a sales chance loss count factor table for recording a buyer evaluation factor with respect to a sales chance loss count. FIG. 11 is a diagram showing a data structure of a buyer-oriented detailed output file showing details of the buyer evaluations. FIG. 12 is a diagram showing a layout of a degree setting screen on which multiple evaluation degrees and factors are set by an administrator of the present information system. FIG. 13 is a diagram showing an example of manager-oriented buyer evaluation information presented to the manager. FIG. 14 is a diagram showing an example of a buyer-oriented sales chance loss detailed table showing evaluated results presented to the buyers. FIG. 15 is a flowchart showing an information accumulation process in this information processing system. FIG. 16 is a flowchart showing an evaluation calculating process in this information processing system. FIG. 17 is a flowchart showing an option process in this information processing system. FIG. 18 is a flowchart showing details of a buyer code entry process shown in S25 in FIG. 16. FIG. 19 is a flowchart showing a manager-oriented buyer evaluation information creating process in this information processing system. FIG. 20 is a flowchart showing a buyer-oriented sales chance loss detailed table creating process in this information processing system. FIG. 21 is a flowchart showing a screen/document output process in this information processing system. FIG. 22 is a flowchart showing an other system interface process when this information processing system exchanges data with other system.

### System Architecture

FIG. 1 shows the system architecture of the information processing system in this embodiment. This information processing system is configured by a POS (Point Of Sales) terminal 2 or a personal computer 3 (that will hereinafter be abbreviated to PC 3) installed in a retail shop, and a server 1 installed in a head office.

The POS terminal 2 or the PC 3 is used for inputting pieces of loss-of-sales-chance information. A loss of sales chance means that when a customer offers a purchase of a commercial article, there is no stock of this article in the retail shop, and the shop was unable to sell this article. In such a case, a staff worker at this retail shop inputs a piece of information indicating that the loss of sales chance occurs (which is called the loss-of-sales-chance information) on the POS terminal 2 or the PC 3.

In the case of inputting the same information on the POS terminal 2, the staff worker at the retail shop searches for the article with no stock from an article management book. In the article management book, the respective articles are bar-coded with JAN (Japan Article Number) codes. The staff worker inputs, from a bar code reader of the POS terminal 2, a bar code of the article of which the sales chance was lost, and transmits this bar code to the server 1.

On the other hand, when inputting the above information on the PC 2, the staff worker at the retail shop accesses the server 1 through the PC 2, and searches the databases of the server 1 on the basis of a name of the article with no stock. Then, the staff worker specifies the JAN code of this article and inputs the loss-of-sales-chance information to the server 1.

The server 1 includes a database for managing the articles, the staff workers, states of sales etc at the plurality of retail shops, a terminal 15 for displaying various categories of information, a printer 16 for printing the various categories of information, and a communication module 17 for gathering pieces of information from an outside supplier system 4 or a competitor system 5. Further, the above databases of the server 1 includes a loss-of-sales-chance information database 11, an article master database 12, a buyer master database 13 and several kinds of evaluation information database 14.

The loss-of-sales-chance information database 11 is recorded with pieces of loss-of-sales-chance information transmitted from the POS terminal 2 or the PC 3.

The article master database 12 is recorded with a list of articles dealt with in the present information processing system. As illustrated in FIG. 1, each record of the article in the article master database 12 is uniquely identified by the JAN code indicating each article, and consists of various items of article attribute data (corresponding to article information) entered in a “fashionability degree” field, a “presentation term” field and so on.

The buyer master database 13 is recorded with a list of article purchase staff (who will hereinafter be called buyers) administered by the present information processing system. As shown in FIG. 1, each of records in this buyer master database 13 is uniquely identified by a buyer coder indicating each buyer and contains buyer attribute information.

The evaluation information database 14 is recorded with evaluations about the buyers on the basis of the loss-of-sales-chance information. What reflects in this evaluation may be, if obtainable, a state of a stock of the supplier and a state of a stock of the competitor which are gathered through the communication module 17.

This item of evaluation information is outputted to the terminal 15 or the printer 16 in accordance with an indication of an operator. Further, the evaluation information is transferred to other information system, e.g., a personnel/wage system and is reflected in an assessment of each buyer.

### Data Structure

Data structures of various categories of information dealt with in the present information processing system, will hereinafter be explained. FIG. 2 is the diagram showing the data structure of the loss-of-sales-chance information.

Each line in the table shown in FIG. 2 corresponds to each record, i.e., one set of loss-of-sales-chance information in the loss-of-sales-chance information database 11. As shown in FIG. 2, each record of the loss-of-sales-chance information consists of data entered in an “occurrence date” field, an “occurrence shop code” field, an “occurrence shop name” field, an “occurrence sales counter code” field, an “occurrence sales counter name” field, a “loss-of-sales-chance article code” field, an “in-charge salesclerk code” field, an “in-charge salesclerk name” field and a “customer code” field.

The “occurrence date” field is registered with a date when the loss of sales chance occurs, which is recorded by a built-in clock of the POS terminal 2 or the PC 3 shown in FIG. 1.

The “occurrence shop code” field, the “occurrence shop name” field, the “occurrence sales counter code” field and the “occurrence sales counter name” field, are registered with codes and names of a shop and a sales counter where the loss of sales chance occurs. These pieces of data are preset with respect to every shop and every sales counter on the POS terminal 2 or the PC 3 shown in FIG. 1, and entered in the loss-of-sales-chance information database 11 through the POS terminal 2 or the PC 3 when inputting the loss-of-sales-chance information.

The loss-of-sales-chance article code” filed is registered with a JAN code of the loss-of-sales-chance target article. This JAN code is, as touched in the discussion in FIG. 1, read from among the bar codes of the article management book or from the article master database 12 of the server 1, and is entered in the loss-of-sales-chance information database 11.

The “in-charge salesclerk code” field and the “in-charge salesclerk name” field are registered with a code and a name that identify the salesclerk serving the customer when the loss of sales chance occurred. The code and the name of every salesclerk are preset on the POS terminal 2 or the PC 3. Then, when every salesclerk uses the POS terminal 2 or the PC 3, the salesclerk code of the salesclerk himself or herself is authenticated as an operator.

Accordingly, when the salesclerk inputs the loss of sales chance the POS terminal 2 or the PC 3 enters the now-authenticated salesclerk code and name in the loss-of-sales-chance information database 11.

The “customer code” field is registered with a customer code set by the sales clerk when the customer concerned is identified with a member who registered the customer code in the present information processing system. This setting is done by use of, e.g., a magnetic card or an IC card distributed to the registered customer.

FIG. 3 is the diagram showing the data structure of the article master database 12. Each line in the table in FIG. 3 corresponds to one record in the article master database 12. Each record consists of pieces of data about one single article, which are recorded in respective fields. As shown in FIG. 3, each record in the article master base 12 consists of data entered in a “JAN code” field, a “model number” field, a “color” filed, a “size” field, an “item” field, a “sales price” field, a “cost price” field, a “brand code” field, a “brand name” field, a “fashionability degree” field and an “article presentation term” field.

The “JAN code” is a number for uniquely identifying the article concerned. The JAN codes are defined as common article codes in Japan but are compatible with the international common article codes. The present information processing system involves the use of the JAN codes as article identifying codes.

The “model number” is an article model number set by the article provider (the maker or wholesaler). Further, the “color” and the “size” are a color and a size of the article.

The “item” field is registered with information on an article category such as a fashion ring, a shirt, a one-piece and so on. The “sales price” and the “cost price” are a sales price and a purchase price of the article.

The “brand code” and the “brand name” are a code and a name that identify the brand of the article.

The “fashionability degree” may be defined as data indicating how much the article is fashionable. According to the present information processing system, the fashionability degree is set lower as the article exhibits a higher popularity and a larger fluctuation in sales quantity. Further, this fashionability degree is set higher as the article exhibits a less fluctuation in sales quantity and a longer continuity of the sales chance.

The present information processing system evaluates how much the sales chance is lost based on the fashionability degree. For example, the present information processing system judges that the responsibility of the buyer is not heavy even if the loss of the sales chance occurs with respect to the article exhibiting the large fluctuation in sales quantity. While on the other hand, it is judged that the responsibility of the buyer is heavier when the loss of the sales chance occurs with respect to the article exhibiting a smaller fluctuation in sales quantity and a longer continuity of the sales chance.

The “article presentation term” is a term for which the article concerned is presented at retail. The article master database 12 retains pieces of data with respect to a plurality of presentation terms 1 through 5 into which the article presentation term is further divided.

The present information processing system evaluates the degree of the loss of sales chance in terms of a relationship between the date when the loss of sales chance occurs and the presentation term of the article. For example, even if the loss of sales chance occurs at the end of the presentation term, the responsibility of the buyer is judged light. By contrast, if the loss of sales chance occurs at the beginning of the presentation term, the responsibility of the buyer is judged heavy.

FIG. 4 shows the data structure of the buyer master database 13. Each line in the table shown in FIG. 4 corresponds to one record in the buyer master database 13, each record consists of pieces of data about one single buyer.

As shown in FIG. 4, each record in the buyer master database 13 consists of data entered in a “buyer code” field, a “buyer name” field, an “in-charge division code” field, an “in-charge supplier code” field, an “in-charge brand code” field and an “in-charge brand name” field.

The “buyer code” is a code for uniquely identifying each buyer. The “buyer name” is a name of the buyer. The “in-charge division code” and the “in-charge supplier code” are codes indicating a division and a supplier which the buyer takes charge of. The “in-charge brand code” and the “in-charge brand name” are codes specifying a brand and a name of this brand which the buyer takes charge of.

FIG. 5 shows the presentation term degree file. This presentation term degree file is contained in the evaluation information database 14 shown in FIG. 1. This presentation term degree file is stored with an evaluation degree (which may be called a presentation term degree) when the loss of sales chance occurs in each of the presentation terms 1 through 5.

As shown in FIG. 5, according to this embodiment, “5”, “4”m “3”, “2”, “1” are set as the presentation term degrees in the presentation terms 1 through 5. This implies that the responsibility of the buyer becomes heavier as it is closer to the beginning of the article presentation term.

While on the other hand, after the article presentation term has expired, “0” is set as the presentation term degree, which means that the buyer is not called to take the responsibility. Further, the presentation term degree “5” is set for articles requiring no presentation term, i.e., the articles that should be prepared at all times.

FIG. 6 shows the data structure of the supplier inventory factor file. This supplier inventory factor file is also contained in the evaluation information database 14 shown in FIG. 1. The supplier inventory factor file is utilized for reflecting information on whether the supplier had a stock when the loss of sales chance occurred, in evaluating the buyer.

Referring to FIG. 6, when having the stock, the supplier inventory factor is set to “1”, and when having no stock, the factor is set to “0.5”. It can be therefore comprehended that the responsibility of the buyer is relieved (the degree is 0.5) even if the loss of sales chance occurs when the supplier has no stock. By contrast, it can be understood that the supplier has the stock, and, nevertheless, if the loss of sales chance occurs, the responsibility of the buyer is not relieved (the degree is 1).

Note that the information on whether the suppliers having given their consent to provide the information about their own inventories have the stocks, is obtained via a network.

FIG. 7 shows the data structure of the competitor inventory factor file. This competitor inventory factor file is likewise contained in the evaluation information database 14 shown in FIG. 1. The competitor inventory factor file is utilized for reflecting information on whether the competitor had a stock when the loss of sales chance occurred, in evaluating the buyer.

Referring to FIG. 7, when having the stock, the factor is set to “3”, and when having no stock, the factor is set to “1”. It can be therefore comprehended that the competitor has the stock, and, nevertheless, if the loss of sales chance occurs, the responsibility of the buyer is called to take a weighted responsibility (the degree is 3). By contrast, it can be understood that even if the loss of sales chance occurs when the trader has no stock, the responsibility of the buyer is not weighted (the degree is 1).

FIG. 8 shows the data structure of a loss-of-chance detailed file. This loss-of-chance detailed file is also contained in the evaluation information database 14 shown in FIG. 1. The loss-of-chance detailed file is utilized as an operation-oriented intermediate data area for evaluating the buyer on the basis of the loss-of-sales-chance information.

As illustrated in FIG. 8, the loss-of-chance detailed file has a “detailed record No.” field, an “occurrence date” field, an “occurrence shop code”, field, an “occurrence shop name”, field, an “occurrence sales counter code” field, an “occurrence sales counter name” field, an “article code” field, a “minus point” field, a “fashionability degree” field, a “presentation term degree” field , a “supplier inventory factor” field, a “competitor inventory factor” field, a “brand code” field and a “buyer code” field.

The “occurrence date”, the “occurrence shop code”, the “occurrence shop name”, the “occurrence sales counter code” and the “occurrence sales counter name” among those items, are the same data as those described in the loss-of-sales-chance information database. Further, the “article code” is the same as the loss-of-sales-chance article code in the loss-of-sales-chance information database.

Further, the “fashionability degree”, the “brand code” and the “buyer code” are the same data as those specified in the article master database 12.

Moreover, the “presentation term degree”, the “supplier inventory factor” and “competitor inventory factor” are the degree and factors determined in a presentation term degree file, a supplier inventory factor file and a competitor inventory factor file, depending on a date when the loss-of-sales-chance occurs, a state of the supplier inventory, and a state of the competitor inventory.

On the other hand, the “detailed record No.” is a unique number for identifying each record in the loss-of-chance detailed file. Further, the “minus point” is defined as a buyer evaluation point determined from the sales price in the article master database 12, the fashionability degree, the presentation term degree, the supplier inventory factor and the competitor inventory factor. This evaluation point, however, indicates an evaluation based on the loss of sales chance and a minus point representing a point deducted.

The present information system evaluates each buyer on the basis of this loss-of-chance detailed file. Then, the evaluated results are gathered and outputted to the Terminal 15 or the printer 16 shown in FIG. 1.

FIG. 9 shows the data structure of the buyer-by-buyer evaluation information file. This buyer-by-buyer evaluation information file is also contained in the evaluation information database 14 shown in FIG. 1. The buyer-by-buyer evaluation information is generated for outputting a monthly buyer evaluation for a manager.

Each record in this buyer-by-buyer evaluation information file has a “buyer code” field, a “month” field, a “minus point accumulated value” field, a “sales chance loss count” field and a “final evaluation value” field.

The “buyer code” among these items is a code uniquely identifying an evaluation target buyer. Further, the “month” indicates a month for which the buyer is evaluated. The “minus point accumulated value” is a value obtained by adding up the minus points in the month buyer by buyer, which are entered in the respective records of the loss-of-chance detailed file shown in FIG. 8.

The “sales chance loss count” is a monthly accumulated count of the losses of sales chance with respect to the article which the buyer concerned takes charge of. The “final evaluation value” is a value into which the minus point accumulated value is converted with the sales chance loss count.

FIG. 10 shows the data structure of the sales chance loss count factor file. This filed is stored with an evaluation factor corresponding to the monthly sales chance loss count. To be specific, the responsibility of the buyer is set heavier with a larger sales chance loss count per month in such a way that a factor “1” is set for the counts 1 through 10, and a factor “1.2” is set for the counts 11 through 20.

The final evaluation value in FIG. 9 is a result of evaluating the minus point accumulated value in accordance with the factors in this sales chance loss count factor file.

FIG. 11 shows the data structure of the buyer-oriented detailed output file. This buyer-oriented detailed output file is also contained in the evaluation information database 14 shown in FIG. 1. The buyer-oriented detailed output file is generated buyer by buyer for outputting details of the evaluation.

Each record in the buyer-oriented detailed output file is generated corresponding to the record in the loss-of-sales-chance information database. Each record in the buyer-oriented detailed output file has a “buyer code” field, a “month” field, a “date” field, a “shop” field, a “sales counter” field, an “article name” field, an “article code” field, a “sales price” field, a “presentation term” field and a “minus point” field. The respective records in this buyer-oriented detailed output file are sorted on a buyer-by-buyer basis and a monthly basis, and are presented as details of the evaluated results to the individual buyers.

### Evaluation Method and Degree Setting Screen

A method of evaluating the buyer in the present information processing system and a setting screen for setting the degrees used for the evaluation thereof, will hereinafter be explained.

According to the present information processing system, a minus point for the buyer evaluation per loss of sales chance is calculated by the following formula 1, and an option evaluation can be given by the following formula 2:

[Formula 1]

Minus Point=(Sales Price of Article with Loss of Sales Chance)×(Fashionability Degree)×(Presentation Term Degree)

[Formula 2]

Option Evaluation=(Minus Point)×(Supplier Inventory Factor)×(Competitor Inventory Factor)

If unable to obtain the information on whether the supplier has the stock or whether the competitor has the stock, however, “1” is set in the corresponding factor, i.e., the supplier inventory factor or the competitor inventory factor. A process of calculating the option evaluation is called an option process.

FIG. 12 shows a layout of the degree setting screen. This degree setting screen is displayed on the Terminal 15 shown in FIG. 1 and is used for the administrator of the information system to set the variety of degrees and factors in the formula 1. This degree setting screen contains, from an upper area on the screen, a fashionability degree setting window 151, a presentation term degree setting window 152, a supplier inventory factor setting window 153, a competitor inventory factor setting window 154 and a sales chance loss count factor setting window 155.

A fashionability degree is set in the fashionability degree setting window 151. This fashionability degree is specified corresponding to a degree of how much the sales quantity of the article changes.

In an example shown in FIG. 12, a degree “1” is set for a fashion article such as lady's wear etc sold out at a short cycle. Further, a degree “3” is set for a fashion standard article presented for a considerable period of time. Moreover, a degree “5” is set for a standard article such as shirts, underwear and so forth, of which stocks should be kept throughout the year.

The set degrees are stored in an unillustrated article-type-basis degree table. Then, this table is referred to when registering the article in the article master database 12, the above degree is, as shown in FIG. 3, set as a fashionability degree for every article corresponding to the type of every article.

The degrees are set with respect to items such as “no presentation term”, “the first through fifth terms” and “after the presentation” in the presentation term degree setting window 152. The number of terms is set or changed by the administrator of the present information system.

With this change, the information in the article master database 12 and the information in the presentation term degree file, are updated. For example, it is assumed that the administrator sets a degree “5” for “no presentation term”, the number of terms to “5”, degrees for the first through fifth terms to “5”, “4”, “3”, “2”, “1” respectively, and a degree for “after the presentation” to “0”.

Then, at first, the article presentation term in the article master database 12 is divided by 5. Further, the number of terms in the presentation term degree file is set to 5, an the degrees given above are registered. Then, when the loss of sales chance occurs, the term is determined (specified) from relationship between an occurrence date and a presentation term thereof, and the degree given above is cited.

The respective degrees in the case of having the stock and the case of having no stock, are set in the supplier inventory factor setting window 153. Thus set degrees are registered in the supplier inventory factor file shown in FIG. 6. Then, if the loss of sales chance occurs and when obtaining the information on whether the supplier has the stock or not, those factors are cited.

The respective degrees in the case of having the stock and the case of having no stock, are set in the competitor inventory factor setting window 154. Thus set degrees are registered in the competitor inventory factor file shown in FIG. 7. Then, if the loss of sales chance occurs and when obtaining the information on whether the competitor has the stock or not, those factors are cited.

A factor for the sales chance loss count per month is set in the sales chance loss count factor window 155. This set value is registered in the sales chance loss count factor file shown in FIG. 10. Then, the set value is cited when monthly gathering the minus points and used for calculating a final evaluation value in the buyer-by-buyer evaluation information file shown in FIG. 9.

### Output Screen and Structure of Document

A screen displayed in the present information processing system and a structure of a document outputted, will hereinafter be described. FIG. 13 shows a structure of buyer evaluation information for the manager. Pieces of buyer evaluation information are sorted in the form of a monthly list based on the records in the buyer-by-buyer evaluation information file shown in FIG. 9, and are displayed on the Terminal 15 or outputted in a document format to the printer 16 shown in FIG. 1.

The buyer evaluation information for the manager has a “section” field, a “buyer name” field, a “employee No.” field, a “sales chance loss count” field, a “minus point” field, a “final evaluation value” field, and a “minus point term-basis accumulation” field.

FIG. 14 shows a buyer-oriented loss-of-sales-chance detailed table. This detailed table is what pieces of information based on the buyer-oriented detailed output file shown in FIG. 11 are outputted on the buyer-by-buyer basis and on the monthly basis to the Terminal 15 or the printer 16.

A month concerned and an employee No. of the buyer concerned are shown at the top of this buyer-oriented loss-of-sales-chance detailed table. Further, the details of the loss of sales chance in the month concerned with respect to the buyer concerned are displayed as a list.

Each line in this detailed table has an “occurrence date” field, a “shop” field, a “sales counter” field, an “article name” field, a “JAN code” field, a “sales price” field, a “presentation term” field and a “minus point” field entered when the loss occurs each time.

Further, the final evaluation value based on the accumulated value of the minus points per month and the sales chance loss count factor, is shown in the lowest area in this detailed file.

### Operation and Effect

FIGS. 15 through 22 show the processes of the program executed by this information processing system. FIG. 15 is the flowchart showing an information accumulation process executed when the loss-of sales chance occurs. This process is defined as an online process executed whenever the loss of sales chance occurs.

If there is no stock when the customer offers a purchase of an article at the retail shop, a loss of sales chance occurs (S10). Then, the salesclerk in charge inputs a piece of loss-of-sales-chance information on the POS terminal 2 or the PC 3 (S11).

Then, the loss-of-sales-chance information is transmitted to the server 1 defined as a host computer and accumulated on the loss-of-sales-chance information database 11 (S12).

FIG. 16 shows an evaluation calculating process. This process is a batch process booted at a predetermined time or timing.

In this process, at first, the server 1 reads loss-of-sales-chance information (S20). Next, the server 1 searches the article master database 12, herein a JAN code of the thus-read record is used as a key. Then, the server 1 extracts a sales prices, a fashionability degree and a presentation term from the article master database 12 (S21).

Next, the server 1 calculates a minus point of each piece of loss-of-sales-chance information in accordance with the formula 1 given above (S22). Subsequently, the server 1 executes the option process (S23).

Next, the server 1 outputs results of the calculations in S22 and S23 to the loss-of-sales-chance detailed file (S24). Further, the server 1 executes a buyer code entry process (S25) Thereafter, the server 1 finishes the evaluation calculating process.

FIG. 17 shows details of the option process (S23 in FIG. 16). In this process, to begin with, the server 1 judges whether the supplier inventory information can be obtained (S230)). Herein, the case that the supplier inventory information can be obtained, means that the supplier's consent to provide the inventory information is given and that the consent or non-consent of every supplier is set in an unillustrated supplier management table.

If unable to obtain the supplier inventory information, the server 1 refers to the supplier inventory factor file and sets “1” in the supplier inventory factor (S231). Thereafter, the server 1 advances the control S236.

While on the other hand, if able to obtain the supplier inventory information, the server 1 searches the supplier inventory master database with the JAN code used as a key (S232)

Then, the server 1 judges whether the supplier has the stock (S233). If the supplier has the stock, the server 1 sets “1” in the supplier inventory factor (S234). Whereas if not, the server 1 sets “0.5” in the supplier inventory factor (S235)

Next, the server 1 judges whether the inventory information of the competitor can be obtained (S236). The case that the inventory information of the competitor can be obtained, means that the competitors are a kind of traders trading same category articles in the same capital group mutually exchanging the inventory information, or that the competitors establish an agreement of mutually exchanging the inventory information even when belonging to different capital groups, or that the competitors are capable of searching for the inventory information on the Internet.

With respect to the competitors capable of mutually exchanging the inventory information, an inventory information obtaining possibility or impossibility is set in an unillustrated competitor table. Further, the competitors of which the inventory information can be searched on the Internet includes traders each having an online shopping site on the Internet and disclosing a state of the inventory.

If unable to obtain the inventory information of the competitor, the server 1 refers to the competitor inventory factor file, and sets “1” in the competitor inventory factor (S237). Thereafter, the server 1 advances the control to S23C.

Whereas if able to obtain the inventory information of the competitor, the server 1 searches for the inventory information of the competitor (S238). This is a search for the inventory master database of the competitors capable of mutually exchanging the inventory information, wherein the JAN codes are used as keys. This is also the search for the inventory information, at Web sites in the Internet, of the traders with their inventory master databases unaccessible from the server Then, the server 1 judges whether the competitor has the stock (s239). If the competitor has the stock, the server 1 sets “3” in the competitor inventory factor (S23A). Whereas if the competitor has no stock, the server 1 sets “1” in the competitor inventory factor (S23B).

Next, the server 1 multiplies the minus point calculated in the process in S22 in FIG. 16 by the supplier inventory factor and the competitor inventory factor, thus calculating a final minus point (S23C). Thereafter, the server 1 finishes the option process.

FIG. 18 shows details of the buyer code entry process (S25 in FIG. 16). In this process, to start with, the server 1 reads the loss-of-sales-chance detailed file (FIG. 8) created in the process in S24 in FIG. 16 (S250).

Next, the server 1 searches the buyer master database 13 (see FIG. 4) by using the brand code of the read-in record as a key, and reads the buyer code (S251).

Subsequently, the server 1 enters the buyer code in the “buyer code” field of the relevant record in the loss-of-sales-chance detailed file (S252). Thereafter, the server 1 finishes the buyer code entry process.

FIG. 19 shows a process of creating the buyer evaluation information for the manager. This process is also a batch process executed at a predetermined time or timing. In this process, at first, the server 1 reads the loss-of-sales-chance detailed file (FIG. 8) (S40).

Next, the server 1 gathers the minus points on the buyer-by-buyer basis and outputs the gathered point to the buyer-by-buyer evaluation information file (FIG. 9) (S41).

Subsequently, the server 1 extracts a factor out of the sales chance loss count factor file (FIG. 10) on the basis of the collected sales chance loss counts, and multiplies the minus point accumulated value by this factor. Then, the server enters this multiplied result as the final evaluation value in the buyer-by-buyer evaluation information file (FIG. 9). Thereafter, the server 1 finishes the manager-oriented buyer-by-buyer evaluation information creating process.

FIG. 20 shows the buyer-oriented loss-of-sales-chance detailed table creating process. This process is also a batch 4 process executed at a predetermined time or timing. In this process, at first, the server 1 reads the loss-of-sales-chance detailed file (FIG. 8) (S50).

Next, the server 1 sorts out the records in the loss-of-sales-chance detailed file on the buyer-by-buyer basis and the monthly basis (S51).

Subsequently, the server 1 calculates a sum total on the buyer-by-buyer basis and the monthly basis (S52). Then, the server 1 enters the added result for the month concerned in the buyer-oriented detailed output file (FIG. 11) on the buyer-by-buyer basis (S53). Thereafter, the server 1 finishes the buyer-oriented loss-of-sales-chance detailed file creating process.

FIG. 21 shows the screen/document output process. This process is a process executed when the administrator or the buyer demands. This process involves inputting a condition for selecting an output of the screen or an output of the document from the terminal 15 shown in FIG. 1 or the PC connected to the server 1 installed in an unillustrated office (S60). This selecting condition includes authenticating whether it is the manager or the buyer, and also selecting whether the screen or the document is outputted. The condition selected is inputted to the server 1 from the terminal 15 etc.

Next, the server 1 reads the buyer-by-buyer evaluation information file (FIG. 9) or the buyer-oriented detailed output file (FIG. 11) in accordance with the condition inputted. Then, the server 1 edits the thus read result in a manager-oriented buyer evaluation information format (see FIG. 13) or a buyer-oriented loss-of-sales-chance detailed table format (see FIG. 14), and outputs the thus formatted information to the terminal 15, the printer 16 and so on. Thereafter, the server 1 finishes the screen/document output process.

FIG. 22 shows the other system interface process. This process is a batch process executed at a predetermined time or timing. In this process, the server 1 transmits the buyer-by-buyer evaluation information to other system such as the personnel/wage system and so forth (S70). Thereafter, the server 1 finishes the other system interface process.

As discussed above, according to the present information processing system, the buyer can be objectively evaluated based on the state where the loss of sales chance occurs. In the present information processing system, on the occasion of evaluating the buyer, the characteristics of the target article stored in the article master database 12 are referred to. The evaluation reflecting the sales price and the demand of the target article, the degree of change in the sales quantity and the time within the retail presentation term, can be thereby performed.

Further, the present information processing system involves obtaining as much information on the inventories of the suppliers and the competitors as possible. Then, the evaluation of the buyer reflects the states of how much and whether or not the suppliers and the competitors have the stocks when the loss of sales chance occurred.

With this contrivance, the responsibility of the buyer is set heavy when the supplier has the stock and set light when having no stock, thus evaluating the buyer. Further, the responsibility of the buyer is set heavier when the competitor has the stock and set lighter when having no stock, thus evaluating the buyer.

The information on the article sold out has hitherto been easy to obtain, while the information on the article unsold has hitherto been hard to obtain. According to the present invention processing system, however, pieces of information such as “this article would be sold if stocked” are systematically collected. Therefore, the present information processing system has such an effect that it is possible not only to simply prevent a decrease in sales volume but also to grasp the situations where the customer's trust might be lost and the regular customers might fleet to other competitors (shops).

Then, the present information processing system has the scheme that the evaluation of the buyer with a less loss of sales chance is enhanced, while the evaluation of the buyer with a greater loss of sales chance is degraded. With this scheme, the objectivity of the buyer evaluation increases to stimulate a buyer's enthusiasm about the work, whereby the business efficiency rises.

### Modified Example

The information processing system in the present embodiment is configured by the POS terminal 2 or the PC 3 installed at the counter of the shop, and the server 1 for managing the plurality of shops in concentration. The embodiment of the present invention is not, however, limited to this system.

For example, a shop server ranked between the server 1 and the POS terminal 2 etc may be provided at every shop. The shop server may manage pieces of information peculiar to the shop concerned such as a shop code, a shop name, a sales counter code and a name of the sales counter.

In such a case, unlike the embodiment discussed above, there is no necessity of presetting the shop code, the shop name, the sales counter code and the name of the sales counter on the POS terminal 2 or the PC3. The shop server at every shop may manage those items of data batchwise. Then, when the loss of sales chance occurs, the POS terminal or the PC 3 may inquire of the shop server about those items of data.

According to the embodiment discussed above, the minus point is calculated each time the loss of sales chance occurs, and the minus points are gathered monthly. The embodiment of the present invention is not, however, limited to this procedure.

For example, whenever the loss of sales chance occurs, the loss-of-sales-chance information of every article is accumulated and gathered at an interval of a predetermined period, and, after collecting these pieces of information, the minus points may be calculated. That is, normally, the loss-of-sales-chance information may be accumulated and gathered for the evaluation at the interval of the predetermined period.

According to the embodiment discussed above, the minus points are collected monthly. The embodiment of the present invention is not, however, confined to this procedure. The above interval of the collection period may be properly set corresponding to the system user. For instance, the information may be gathered every week, every ten days, at an interval of a plurality of months, every season, semi annually and annually.

### Readable-by-Computer Recording Medium

A program read by a computer to execute the processes of the server in the embodiment discussed above may be recorded on a readable-by-computer recording medium. Then, the computer reads and executes the program on this recording medium, thereby providing a function as the server 1 shown in the embodiment discussed above.

Herein, the readable-by-computer recording medium embraces recording mediums capable of storing information such as data, programs, etc. electrically, magnetically, optically and mechanically or by chemical action, which can be all read by the computer. What is demountable out of the computer among those recording mediums may be, e.g., a floppy disk, a magneto-optic disk, a CD-ROM, a CD-R/W, a DVD, a DAT, an 8 mm tape, a memory card, etc..

Further, a hard disk, a ROM (Read Only Memory) and so on are classified as fixed type recording mediums within the computer.

### Data Communication Signal Embodied in Carrier Wave

Furthermore, the above program may be stored in the hard disk and the memory of the computer, and downloaded to other computers via communication media. In this case, the program is transmitted as data communication signals embodied in carrier waves via the communication media. Then, the computer downloaded with this program can be made to provide the function as the server 1 in the embodiment discussed above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. An article staff evaluation system comprising:
a module recording article information on an article;
a unit inputting occurrence information indicating an occurrence of a loss of sales chance of the article; and
a unit evaluating an article staff in charge of a trade of the article on the basis of the occurrence information and attributes of the article.

2. An article staff evaluation system according to claim 1, wherein the article information contains a sales price of the article, and
said evaluation unit evaluates the article staff in a way that reflects the sales price of the article.

3. An article staff evaluation system according to claim 1, wherein the article information contains information indicating a continuity of a sales frequency of the article, and
said evaluation unit evaluates the article staff in a way that reflects the continuity of the sales frequency of the article.

4. An article staff evaluation system according to claim 1, wherein the article information contains information indicating a retail presentation term of the article,
the occurrence information contains an occurrence date of the loss of sales chance, and
said evaluation unit evaluates the article staff in a way that reflects a relationship between the occurrence date and the retail presentation term.

5. An article staff evaluation system according to claim 1, further comprising a module referring to information on a state of inventory of a supplier of the article,
wherein said evaluation unit evaluates the article staff in a way that reflects the state of inventory of the supplier.

6. An article staff evaluation system according to claim 1, further comprising a module referring to information on a state of inventory of the article in a competitor,
wherein said evaluation unit evaluates the article staff in a way that reflects the state of inventory of the competitor.

7. An article staff evaluation system according to claim 1, further comprising:
a module accumulating evaluated results, and
a module collecting the evaluated results accumulated.

8. An article staff evaluation system according to claim 1, further comprising:
a module accumulating the occurrence information, and
a module collecting the occurrence information accumulated,
wherein said evaluation unit evaluates the article staff on the basis of the occurrence information collected.

9. An article staff evaluation system according to claim 1, further comprising:
a module integrating the number of occurrences of the loss of sales chance,
wherein said evaluation unit evaluates the article staff in a way that reflects the number of occurrences.

10. An article staff evaluation method comprising:
inputting occurrence information indicating an occurrence of a loss of sales chance of the article;
referring to article information on the article; and
evaluating an article staff in charge of a trade of the article on the basis of the occurrence information and the article information.

11. An article staff evaluation method according to claim 10, wherein the article information contains a sales price of the article, and
said evaluation involves evaluating the article staff in a way that reflects the sales price of the article.

12. An article staff evaluation method according to claim 10, wherein the article information contains information indicating a continuity of a sales frequency of the article, and
said evaluation involves evaluating the article staff in a way that reflects the continuity of the sales frequency of the article.

13. An article staff evaluation method according to claim 10, wherein the article information contains information indicating a retail presentation term of the article,
the occurrence information contains an occurrence date of the loss of sales chance, and
said evaluation involves evaluating the article staff in a way that reflects a relationship between the occurrence date and the retail presentation term.

14. An article staff evaluation method according to claim 10, further comprising referring to information on a state of inventory of a supplier of the article,
wherein said evaluation involves evaluating the article staff in a way that reflects the state of inventory of the supplier.

15. An article staff evaluation method according to claim 10, further comprising referring to information on a state of inventory of the article in a competitor,
wherein said evaluation involves evaluating the article staff in a way that reflects the state of inventory of the competitor.

16. An article staff evaluation method according to claim 10, further comprising:
accumulating evaluated results, and
collecting the evaluated results accumulated.

17. An article staff evaluation method according to claim 10, further comprising:
accumulating the occurrence information, and
collecting the occurrence information accumulated,
wherein said evaluation involves evaluating the article staff on the basis of the occurrence information collected.

18. An article staff evaluation method according to claim 10, further comprising:
integrating the number of occurrences of the loss of sales chance,
wherein said evaluation involves evaluating the article staff in a way that reflects the number of occurrences.

19. A readable-by-computer recording medium recorded with a program, executed by a computer, comprising:
inputting occurrence information indicating an occurrence of a loss of sales chance of the article;
referring to article information on the article; and
evaluating an article staff in charge of a trade of the article on the basis of the occurrence information and the article information.

20. A readable-by-computer recording medium recorded with a program according to claim 19, wherein the article information contains a sales price of the article, and
said evaluation involves evaluating the article staff in a way that reflects the sales price of the article.

21. A readable-by-computer recording medium recorded with a program according to claim 19, wherein the article information contains information indicating a continuity of a sales frequency of the article, and
said evaluation involves evaluating the article staff in a way that reflects the continuity of the sales frequency of the article.

22. A readable-by-computer recording medium recorded with a program according to claim 19, wherein the article information contains information indicating a retail presentation term of the article,
the occurrence information contains an occurrence date of the loss of sales chance, and
said evaluation involves evaluating the article staff in a way that reflects a relationship between the occurrence date and the retail presentation term.

23. A readable-by-computer recording medium recorded with a program according to claim 19, further comprising referring to information on a state of inventory of a supplier of the article,
wherein said evaluation involves evaluating the article staff in a way that reflects the state of inventory of the supplier.

24. A readable-by-computer recording medium recorded with a program according to claim 19, further comprising referring to information on a state of inventory of the article in a competitor,
wherein said evaluation involves evaluating the article staff in a way that reflects the state of inventory of the competitor.

25. A readable-by-computer recording medium recorded with a program according to claim 19, further comprising:
accumulating evaluated results, and
collecting the evaluated results accumulated.

26. A readable-by-computer recording medium recorded with a program according to claim 19, further comprising:
accumulating the occurrence information, and
collecting the occurrence information accumulated,
wherein said evaluation involves evaluating the article staff on the basis of the occurrence information collected.

27. A readable-by-computer recording medium recorded with a program according to claim 19, further comprising:
integrating the number of occurrences of the loss of sales chance,
wherein said evaluation involves evaluating the article staff in a way that reflects the number of occurrences.
